(19) United States
(12) Patent Application Publication
(10) Pub. No.: US 2005/0081240 A1
(43) Pub. Date: Apr. 14, 2005

(54) Digital broadcasting receiver and method for displaying service component of digital broadcasting

(75) Inventors: Jun Kim, Seoul (KR); Sang O. Park, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/954,818

(22) Filed: Sep. 29, 2004

(30) Foreign Application Priority Data
Sep. 29, 2003 (KR) 67453/2003

(51) Int. Cl. G06F 13/00; H04N 7/08

(52) U.S. Cl. 725/38; 725/59

(57) ABSTRACT

Provided are a method for effectively displaying a service component of a digital broadcasting and a digital broadcasting receiver that allow a user to effectively to select a desired service component by displaying the service component contained in one ensemble according to a characteristic of the service component.

### BACKGROUND OF THE INVENTION

1. Field of the Invention

The present invention relates to a method for effectively displaying a service component of a digital broadcasting and a digital broadcasting receiver, and more particularly, to a method for displaying service components of a digital broadcasting in which the service components are sorted and displayed according to their characteristics so as to allow a user to effectively select the service components.

2. Description of the Related Art

Digital Audio Broadcasting (DAB) which had been originally researched in the early 1980's Europe was adopted as Eureka-147 in 1986. The DAB is a system to overcome drawbacks occurring in the conventional radio broadcasting and provide listeners with a new type of service.

As an application of the DAB, a digital multimedia broadcasting (DMB) that transmits MPEG-4 VIDEO/AUDIO together enabling to receive digital broadcasting during movement is also being researched.

In the digital broadcasting, several services may exist in one frequency multiplex (ensemble) and each service is also configured to include several service components.

Referring to FIG. 1, in a DAB, one ensemble includes several services and one service includes a plurality of service components.

In the DAB, the service components can be classified into audio components and data components. The audio components can be transmitted in a stream mode and the data components can be transmitted in a packet mode.

The letter broadcasting is classified into the data component and the audio broadcasting that does not contain additional information is classified into the audio component.

When audio broadcasting including additional information is transmitted in the packet mode in an MPEG2, the audio broadcasting can be classified into the data component.

In the meanwhile, the service components include a variety of components as shown in FIG. 2.

However, if the characteristics of the variety of service components are not properly displayed, the variety of service components may confuse users in selecting a desired service.

For example, although a service component such as ‘KBS traffic broadcasting’ exists, users cannot know whether the traffic information is provided in audio or letter broadcasting. To this end, there is a drawback in that the users cannot select a desired service component easily.

In other words, since the variety of service components are outputted with being mixed without being classified, it is not easy for the users to find out a desired service component.

Accordingly, it is strongly required to allow the users to effectively select a desired service component from the variety of service components.

### SUMMARY OF THE INVENTION

Accordingly, the present invention is directed to a method for effectively displaying a service component of a digital broadcasting and a digital broadcasting receiver that substantially obviate one or more problems due to limitations and disadvantages of the related art.

An object of the present invention is to provide a method for effectively displaying a service component of a digital broadcasting and a digital broadcasting receiver that allow a user to effectively to select a desired service component by displaying the service component contained in one ensemble according to a characteristic of the service component.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a digital broadcasting receiver comprising: a tuner for outputting a baseband signal having a frequency band from a digital broadcasting signal; a channel decoder for decoding the received digital broadcasting signal to extract an audio signal and a data signal from the decoded broadcasting signal; an audio output part including an audio decoder, a digital-to-analog converter, an amplifier and a speaker to decode and output the audio signal; a controller for permitting a service component information to be extracted from the received broadcasting signal, service components to be displayed according to characteristics of the service components, and contents of the service component as selected to be reproduced; and a display unit for displaying the service components and the contents of the selected service component.

In another aspect of the present invention, there is provided a method for displaying a service component of a digital broadcasting, the method comprising: a first step of decoding a baseband signal from a received digital broadcasting signal and separating an audio signal and a data signal from the received digital broadcasting signal; a second step of extracting a service component information contained in one ensemble from the data signal; and a third step of extracting a human readable label from the service component information and displaying the service component on a discriminated separate area according to a characteristic of the service component.

In a further aspect of the present invention, there is provided a digital broadcasting receiver comprising: means for receiving a digital broadcasting signal; means for decoding the digital broadcasting signal; audio output means for outputting an audio signal of the digital broadcasting; video output means for outputting a video signal of the digital broadcasting; and control means for permitting a service component of the received digital broadcasting to be extracted, the service components to be arranged and displayed according to characteristics of the service components, and contents of the service component as selected to be outputted.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a construction of an ensemble and service components according to the related art;

FIG. 2 is a view illustrating a type of a service component according to the related art;

FIG. 3 is a block diagram of a digital broadcasting receiver according to the present invention;

FIG. 4 is a view of the displayed service components according to an embodiment of the present invention;

FIG. 5 is a flowchart illustrating a method for displaying the service components of the digital broadcasting according to the present invention; and

FIG. 6 is a view illustrating a digital broadcasting receiver according another embodiment of the present invention.

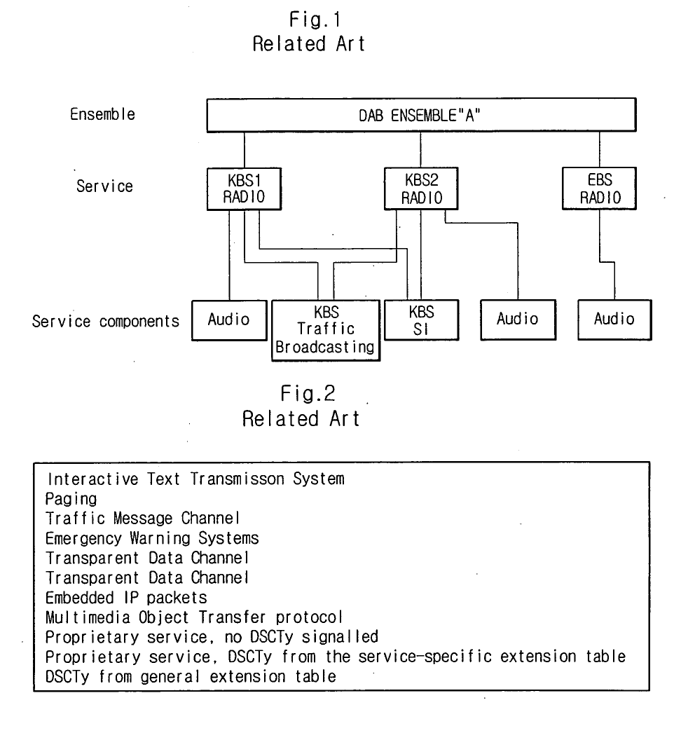

### DETAILED DESCRIPTION OF THE INVENTION

Reference will now be made in detail to the preferred embodiments of the present invention, examples of which are illustrated in the accompanying drawings.

A digital broadcasting receiver and a method for effectively selecting service components in a digital broadcasting according to the present invention will now be described in detail with reference to the accompanying drawings.

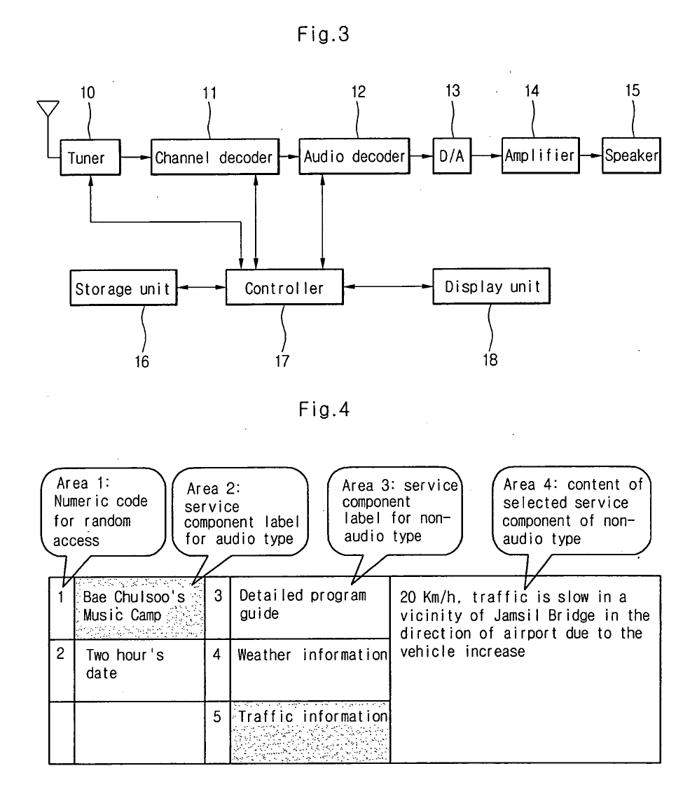

FIG. 3 is a block diagram of a digital broadcasting receiver according to the present invention.

Referring to FIG. 3, a digital broadcasting receiver according to the present invention includes a tuner 10, a channel decoder 11, an audio output unit, a storage unit 16, a controller 17, and a display unit 18. The tuner 10 outputs a baseband signal having a predetermined frequency band, which a user selects from an incoming digital broadcasting signal. The channel decoder 11 decodes the baseband signal to extract an audio signal and data signal. The audio output unit includes an audio decoder 12 for decoding the audio signal and outputting a decoded audio signal, a digital-to-analog converter 13, an amplifier 14, and a speaker 15. The storage unit 16 stores a predetermined data. The controller 17 controls the above-described construction, extracts service component information from the received signal, and displays service components depending on service component characteristics. The display unit 18 displays lists of the service components or contents of the selected service components.

In more detail, the channel decoder 11 includes a synchronizer, an OFDM demodulation, a deinterleaver, and a FEC. Also, the channel decoder 11 performs a synchronization, decoding and error correction with respect to an incoming signal.

After extracting an audio signal and data signal, the channel decoder 11 transmits the audio signal to the audio decoder 12 and transmits the data signal to the display unit 18 through the controller 17.

The data signal may include JPEG format data. The digital broadcasting receiver may further include a JPEG decoder for displaying the JPEG format data through the display unit 18.

Meanwhile, the ensemble, the service and the service components have a machine readable identifier and a human readable label.

The controller 17 extracts the machine readable identifier and the human readable label from the signal decoded by the channel decoder 11.

The machine readable identifier consists of binary number and allows the controller 17 to recognize the ensemble, the service and the service components. The human readable label consists of letters and allows them to be displayed through the display unit 18.

The digital broadcasting receiver according to the present invention classifies the service components into an audio type and non-audio type and uses the human readable label to display them.

The audio type and the non-audio type can be distinguished by fast information channel (FIC) information of the transmitted signal.

FIG. 4 is a view of the displayed service components according to an embodiment of the present invention.

Referring to FIG. 4, the service components can be classified and displayed depending on their characteristics. In this embodiment shown in FIG. 4, the service components are classified into the audio type and non-audio type.

First, an area 1 is a randomly assigned numeric code. That is, a serial number is assigned to every service components in a retrieval order. The service components can be selected at random using a numeric key of a remote controller.

In areas 2 and 3, the service components are classified into the audio type and non-audio type in different columns. The service components are displayed so that only one service component can be selected at one column.

That is, the audio type service components are arranged in the area 2, and the non-audio type service components are arranged in the area 3. In this manner, while the service components can be respectively selected at the areas 2 and 3, two components cannot be simultaneously selected at the areas 2 and 3.

If a first service component is selected at the area 2 and a second service component is selected, a display of the first service component is stopped and the second service component is displayed.

For example, when two audio type service components are displayed at the same time, it is impossible to normally listen to the broadcasting. Therefore, it is preferable that one service component is displayed at one area.

FIG. 4 shows that “Bae Chulsoo's music camp” of the area 2 and “Traffic information” of the area 3 are selected.

The contents of the non-audio type service component are displayed at the area 4. That is, the contents of “Traffic information” selected from the non-audio type service component of the area 3 are displayed.

In this manner, the service components contained in one ensemble are displayed in rows and columns depending on their characteristics, such that the user can effectively select the service components.

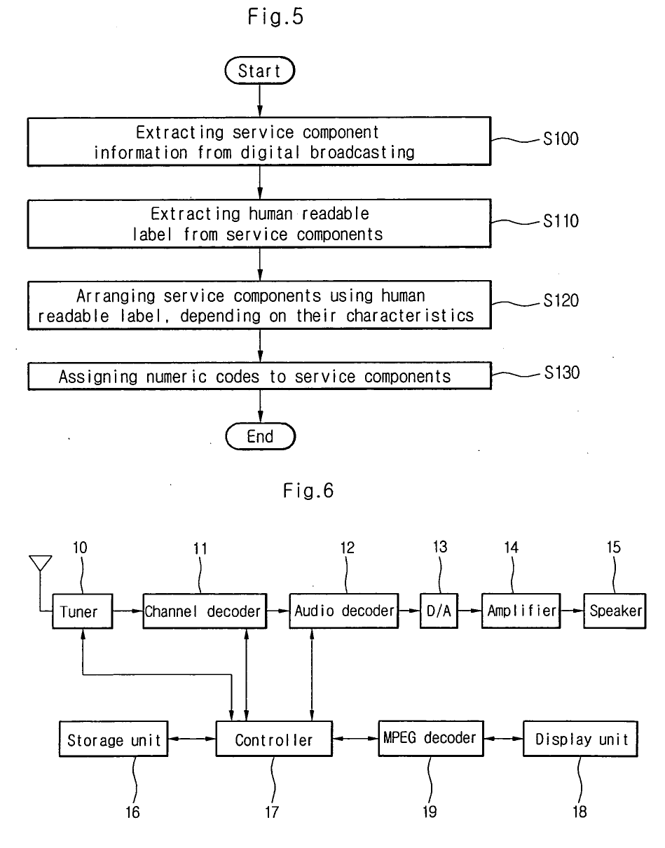

FIG. 5 is a flowchart illustrating a method for displaying the service components of the digital broadcasting according to the present invention.

First, service component information included in one ensemble is extracted from a received digital broadcasting (S100).

Additionally, a human readable label is extracted from each of the service components, and the human readable label is used to arrange the service components depending on their characteristics. At this time, the characteristics of the service components can be distinguished in an audio type and a non-audio type to display the service components in row and column.

In other words, the service components are distinguished in the audio type and the non-audio type to separately display the service components in column such that only one service component can be concurrently selected in one column.

Additionally, it is desirable that contents of the service components of the non-audio type are displayed at one side (S110)(S120).

Together with this, numeric codes are assigned to the service components such that a user can arbitrarily select the service component.

However, at this time, in case where a touch screen is employed in the display unit, it is not required to separately assign the numeric codes, and the numeric code can be allowed to select a corresponding service component by using a numeric key of a remote controller (S130).

Alternatively, FIG. 6 is a view illustrating a digital broadcasting receiver according another embodiment of the present invention.

The embodiment of FIGS. 3 to 5 describes a case where an audio broadcasting and a character broadcasting are transmitted, but can be also applied to a case where a mobile image is transmitted.

The mobile image of a Moving Picture Experts Group (MPEG)-4 format can be transmitted to the service component. In this case, an MPEG decoder 19 is additionally provided to decode a compressed mobile image as shown in FIG. 6.

The channel decoder 11 decodes a baseband signal outputted from the tuner 10 to extract an audio signal, a data signal and a video signal.

The audio signal is reproduced through an audio outputting unit including an audio decoder 12, a digital/analogue converter (D/A) 13, an amplifier 14 and a speaker 15. The video signal is decoded through the MPEG decoder 19 and reproduced through a display unit 18.

In this case, the service components can be distinguished in an audio type, a teletext type and a video type. Each of the service components is separately distinguished and displayed in column or row, and only one service component can be concurrently selected in one column or row.

At this time, a display screen for allowing the user to select the service component is divided into an area where the numeric codes are assigned to allow the user to easily select the service components, an area where the service components of the audio type, the teletext type and the video type are distinguished in column and are displayed using the human readable label, and an area where the contents of the selected teletext-type and video-type service components are displayed.

Accordingly, the service components of the audio type, the teletext type and the video type included in one ensemble are distinguished and displayed in row or column depending on their characteristics such that the user can effectively select the service components.

The present invention has an advantage in that a plurality of service components included in one ensemble is arranged and displayed depending on their characteristics in the digital broadcasting to allow the user to effectively select a specific service component.

Further, the present invention has an advantage in that the service components are distinguished and displayed in the audio type and the non-audio type, and the contents of the service component of the non-audio type are separately displayed to allow the user to easily acquire desired information.

Furthermore, the present invention has an advantage in that the service components are distinguished and displayed in the audio type, the teletext type and the video type to allow the user to easily select the desired components.

It will be apparent to those skilled in the art that various modifications and variations can be made in the present invention. Thus, it is intended that the present invention covers the modifications and variations of this invention provided they come within the scope of the appended claims and their equivalents.

1. A digital broadcasting receiver comprising:
a tuner for outputting a baseband signal having a frequency band from a digital broadcasting signal;
a channel decoder for decoding the received digital broadcasting signal to extract an audio signal and a data signal from the decoded broadcasting signal;
an audio output part including an audio decoder, a digital-to-analog converter, an amplifier and a speaker to decode and output the audio signal;
a controller for permitting a service component information to be extracted from the received broadcasting signal, service components to be displayed according to characteristics of the service components, and contents of the service component as selected to be reproduced; and
a display unit for displaying the service components and the contents of the selected service component.

2. The digital broadcasting receiver according to claim 1, wherein the service components are classified into an audio type and a non-audio type as displayed.

3. The digital broadcasting receiver according to claim 1, wherein each of the service components has a numerical code assigned fro a user's selection.

4. The digital broadcasting receiver according to claim 2, wherein the audio type service components and the non-audio type service components are classified in rows and columns as displayed.

5. The digital broadcasting receiver according to claim 4, wherein the service components that are classified in the rows or columns are selected respectively one by one from the service components arranged on the rows or columns.

6. The digital broadcasting receiver according to claim 2, wherein the service component further comprises a separate area such that the non-audio type service component can be displayed.

7. A method for displaying a service component of a digital broadcasting, the method comprising:
a first step of decoding a baseband signal from a received digital broadcasting signal and separating an audio signal and a data signal from the received digital broadcasting signal;
a second step of extracting a service component information contained in one ensemble from the data signal; and
a third step of extracting a human readable label from the service component information and displaying the service component on a discriminated separate area according to a characteristic of the service component.

8. The method according to claim 7, wherein the service components are classified into an audio type and a non-audio type as displayed.

9. The method according to claim 7, further comprising assigning a numeric code for a user's selection to each of the service components.

10. The method according to claim 8, wherein the audio type service components and the non-audio type service components are classified in rows or columns as displayed.

11. The method according to claim 10, wherein the service components that are classified in the rows or columns are selected respectively one by one from the service components arranged on the rows or columns.

12. The method according to claim 8, further comprising displaying contents of the corresponding service component when the non-audio type service component is selected.

13. A digital broadcasting receiver comprising:
means for receiving a digital broadcasting signal;
means for decoding the digital broadcasting signal;
an audio output means for outputting an audio signal of the digital broadcasting;
a video output means for outputting a video signal of the digital broadcasting; and
a control means for permitting a service component of the received digital broadcasting to be extracted, the service components to be arranged and displayed according to characteristics of the service components, and contents of the service component as selected to be outputted.

14. The digital broadcasting receiver according to claim 13, wherein the service components are classified into at least two selected from the group consisting of a video type, an audio type and a teletext type.

15. The digital broadcasting receiver according to claim 13, wherein each of the service components has a numerical code assigned fro a user's selection.

16. The digital broadcasting receiver according to claim 13, wherein the control means permits the service components to be arranged and displayed in a column or a row according to characteristics of the service components.
